(19) United States
(12) Patent Application Publication
(10) Pub. No.: US 2008/0244129 A1
(43) Pub. Date: Oct. 2, 2008

(54) MASTER DEVICE OF TWO-WIRE BUS PROVIDING RELEASE FUNCTION FOR CLOCK LINE AND METHOD THEREOF

(75) Inventor: Tyng-Horng Tsai, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/693,176

(22) Filed: Mar. 29, 2007

(51) Int. Cl. G06F 13/00

(52) U.S. Cl. 710/107

(57) ABSTRACT

Disclosed is a master device which is capable of communicating with a salve device via a two-wire bus having a clock line and a data line. The master device includes a data port, a clock port and an output port. The output port is also coupled to the clock line. When the clock is held by the slave device for exceeding a predetermined stretching period, the output port can transmit at least one clock pulse generated by the master device to the slave device through the clock line to prevent transmission failure or data corruption. The master device checks each time whether or not a response is received via the data port after the output port transmits the clock pulse generated by the master device. The response represents that releasing the clock is confirmed. Then, the data port transmits a stop pulse after releasing the clock.

### FIELD OF THE INVENTION

The present invention generally relates to a master device of a two-wire bus, and more particularly to a master device of a two-wire bus providing a release function for a clock line and method thereof.

### BACKGROUND OF THE INVENTION

Two-wire bus with a data line and clock line has become a popular standard nowadays. Such as Inter Integrated Circuit (I²C), CAN-Bus, System Management BUS (SMBus), those support any IC fabrication process can be illustrated. The data line (SDA) and the clock line (SCL) carry any information between devices connected to the two-wire bus, and any devices connected to the two-wire bus can be recognized by a unique address. Initially, only one device is defined as a master device in a two-wire bus control system. Other devices are defined as slave devices. Taking I²C standard as an example, generation of the clock is always the responsibility of the master device but data transmission is a bi-directional behavior in any two-wire bus. More detail information of I²C standard can be obtained by referring to the U.S. Pat. No. 4,689,740 and the I²C specification version 2.1, January 2000.

The bus clock pulses from a master device can be altered when the clock pulses are stretched by a slave device by holding the clock LOW because the slave device is too slow to receive or transmit the data with the clock of the master device. Although the two-wire bus standard may not enact a legal stretching period for holding the clock, some defect slave devices may hold down the clock too long, thus result in transmission failure or data corruption. The whole two-wire bus control system may get trapped into an unknown state and thereby resetting the whole two-wire bus control system becomes necessary.

According to prior arts, a bit bang is accomplished by rapidly tweaking the data and clock pulse output bit, such as sending a series of STOP conditions to the slave device may have a chance to recover the clock. Alternatively, adding a logic judgment circuit into the two-wire bus control system for analyzing and solving such problem is also proposed. However, the former does not efficiently recover the clock according to hundreds of tests by inventor's experiments, and the latter of adding a hardware circuit increases cost and complexity of the two-wire bus control system.

Consequently, a master device providing a release function that can release the clock line more efficiently and simpler for all designers, manufacturers of the two-wire bus control system and the method thereof is desirable to solve aforesaid drawbacks of prior arts and thus meets the easy, simple demand and spirit of two-wire bus standard.

### SUMMARY OF THE INVENTION

To solve the foregoing drawbacks in the prior art, it is an objective of the present invention to provide a master device of a two-wire bus that provides a release function for a clock line and method thereof.

The master device which is capable of communicating with a salve device via a two-wire bus having a clock line and a data line includes a data port, a clock port and an output port. The data port transmits and receives data through the data line. The clock port transmits a clock to the slave device through the clock line. The output port is also coupled to the clock line. When the clock is held by the slave device for exceeding a predetermined stretching period, the output port can transmit at least one clock pulse generated by the master device to the slave device so that the slave device releases the clock line. The output port can be a GPIO port. The output port stops transmitting the clock pulse when the salve device receives a complete clock. The master device checks whether or not a response is received via the data port after the output port transmits the clock pulse each time. The response represents that releasing the clock line is confirmed. Then, the data port transmits a stop pulse after releasing the clock via the data port.

The present invention also provides a method for releasing a clock line held by a salve device of a two-wire bus for exceeding a pre-determined time period. The method includes steps described below:

confirming whether or not a clock is held by a slave device; and

transmitting at least one clock pulse generated by a master device to the slave device when the clock is held for exceeding a predetermined stretching period.

The method of the present invention further includes a step of checking whether or not a response is received after the step of transmitting the clock pulse each time. Releasing the clock line is confirmed by receiving the response via the data port.

The method of the present invention further includes a step of transmitting a stop pulse via the data port to the slave device after the step of transmitting the clock pulse.

According to the present invention, the master device can provides a release function and method thereof for the clock line no matter what reason for that the slave device holds the clock generated by the master device. Significantly, the present invention achieves such release function without adding any hardware which means no cost increases for manufacturing apparatus in whichever the two-wire bus is employed inside. Furthermore, the release function provided by the present invention has much more reliability of releasing the clock line rather than other plans proposed by prior arts.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a simplified block diagram of a two-wire bus in which a master device provides a release function for a clock line and a pulse flow diagram of data and clock according to a first embodiment of the present invention;

FIG. 2 illustrates a simplified block diagram of a two-wire bus in which both the data port and clock port of a master device are realized by GPIO ports wherein the master device provides a release function for a clock line and a pulse flow diagram of data and clock according to a second embodiment of the present invention;

FIG. 3 illustrates a block diagram of a computer system capable of intercommunicating inside through a two-wire bus according to the present invention;

FIG. 4 depicts a flowchart of a method for releasing a clock line according to the first embodiment of the present invention; and

FIG. 5 depicts a flowchart of a method for releasing a clock line according to the second embodiment of the present invention.

### DETAILED DESCRIPTION OF THE INVENTION

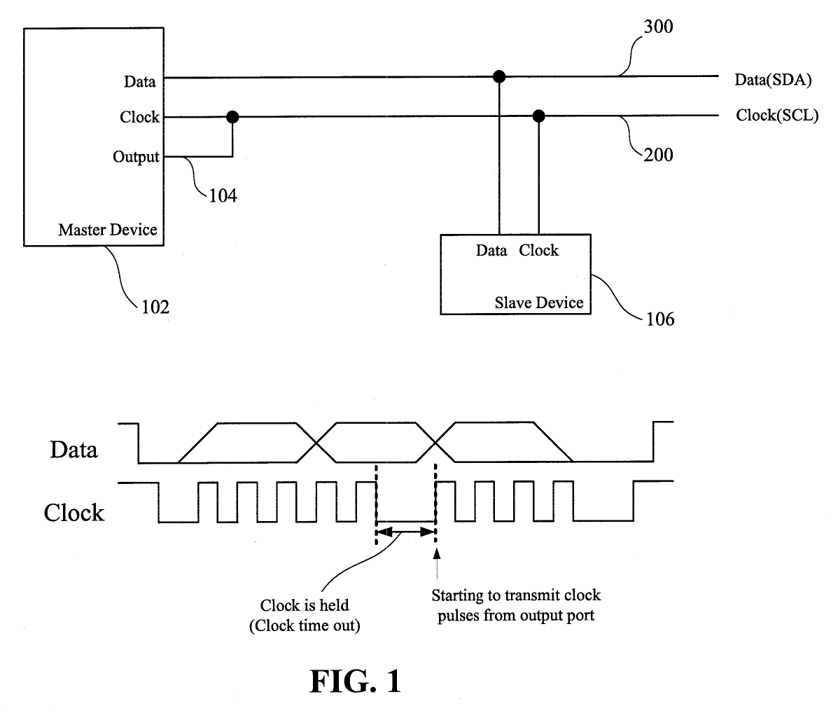

Please refer to FIG. 1, which illustrates a simplified block diagram of a two-wire bus in which a master device 102 is capable of providing a release function for a clock line 200 and a pulse flow diagram of data line 300 and clock line 200 according to a first embodiment of the present invention. In the first embodiment, a slave device 106 of the two-wire bus is coupled with the master device 102. The master device 102 includes a data port, a clock port and an output port. Generally, the output port can be a GPIO port. The data port transmits and receives data to/from the slave device 106 through the data line 300. The clock port transmits a clock generated by the master device 102 to the slave device through the clock line 200. The output port is also coupled to the clock line 200 by a wiring line 104 as shown in FIG. 1.

Taking the I²C standard as an example, one complete data transmission includes 9 clock pulses (bits). If the slave device 106 can't receive or transmit another complete byte of data (with 9 clock bits) until it has performed some function, for example servicing an internal interrupt or being busy to be accessed for the data inside by some outer device, it can hold the clock LOW to force the master device 102 into a wait state. Then, the master device 102 cannot transmit any clock pulse to the slave device 106. The slave device 106 keeps the received clock pulses (for example 5 clock bits) in a register (not shown in FIG. 1) thereof. According to the I²C standard, until the 4 clock bits remaining is received by slave device 106, the master device 102 is kept in the wait state. Once the slave device 106 receives the 4 clock bits remaining, data transfer then continues because the slave device 106 is ready for receiving another byte of data and releases clock line 200.

Generally, the master device 102 does not know how many clock pulses have already been transmitted by itself to the salve device 106. Please refer to the pulse flow diagram in FIG. 1, the slave device 106 may hold the clock line for some reason after 5 clock pulses and the corresponding data bytes have been transmitted. The present invention may define a predetermined stretching period set by a timer to allow the slave device 106 to hold the clock. The timer can be achieved by a hardware circuit, software or firmware. After the slave device 106 holds the clock for exceeding the predetermined stretching period, the master device 102 starts to try releasing the clock line held by the slave device 106.

Therefore, an output port, such as a GPIO port, is employed to start to transmit one clock pulse generated by master device 102 to the slave device 106 through the clock line. Then, the master device 102 checks whether or not a response (acknowledgement signal) is received via the data port after the GPIO port transmits the clock pulse. If the response is received, releasing the clock line is confirmed thereby. If the response is not received, the GPIO port keeps transmitting one clock pulse to the slave device 106 one time, and the master device 102 checks whether or not a response is received after the GPIO port transmits the clock pulse each time. Such procedure will be carried on by the master device 102 until releasing the clock line is confirmed by receiving the response via the data port. In this embodiment, the clock line can be released after the GPIO port transmits 4 clock pulses. The register of the slave device 106 obtains a complete clock. A complete clock includes 9 clock pulses (bits). The response is an acknowledgement pulse generated by the slave device 106. After releasing the clock line is confirmed, the data port transmits a stop pulse generated by the master device 102. In the I²C standard, that is a STOP condition generated by the master device 102. Accordingly, the one complete data transmission is done and thus next data transmission goes on.

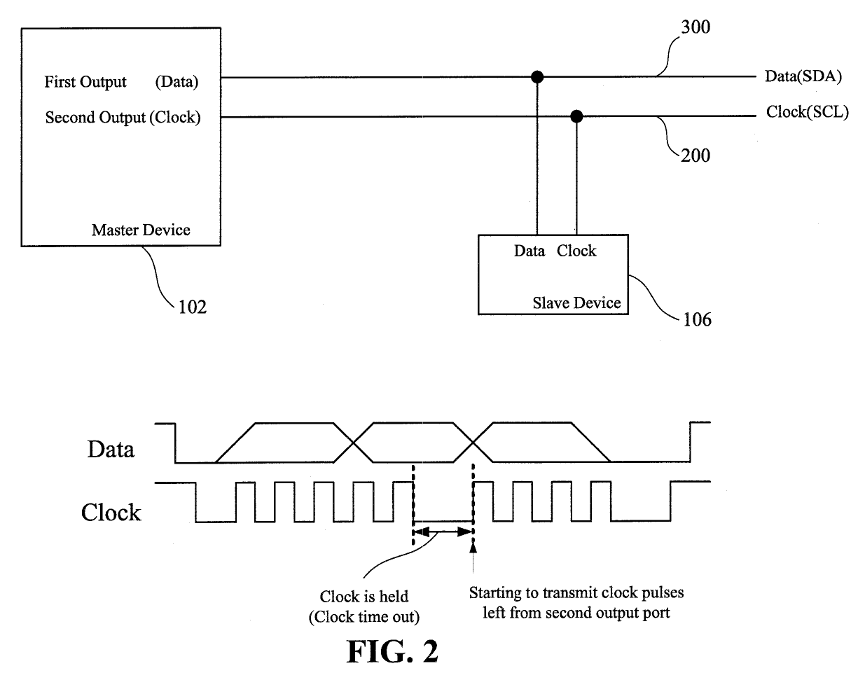

FIG. 2 illustrates a simplified block diagram of a two-wire bus in which the master device 102 provides a releasing function for a clock line 200 and a pulse flow diagram of data line 300 and clock line 200 according to a second embodiment of the present invention. Similarly as described in first embodiment referred in FIG. 1, but to be more specifically, both a first output port (data port) and a second output port (clock port) of the master device 102 are realized by GPIO ports. Significantly, the master device 102 can know how many clock pulses that it has already transmitted.

Again, taking the I²C standard as an example, Please refer to the pulse flow diagram of one complete data transmission with 9 clock pulses (bits) shown in FIG. 2, 5 clock pulses and the corresponding data has been transmitted to the salve device 106, the slave device 106 also holds the clock for some reason. The present invention still defines a predetermined stretching period to allow the slave device 106 to hold the clock. If the slave device 106 holds the clock for exceeding the predetermined stretching period, the master device 102 starts to try releasing the clock line 200 held by the slave device 106. Therefore, the second GPIO port (clock port) is employed to transmit 4 clock pulses remaining generated by the master device 102 to the slave device 106 according to the I²C standard. Then, the master device 102 checks whether or not a response is received via the first GPIO port (data port) after the second GPIO port transmits the remaining clock pulses.

After the response is received, releasing the clock line 200 is confirmed thereby. If the response is not received, re-transmitting the remaining clock pulses again may be executed for attempting to release the clock line 200. In this embodiment, after releasing the clock line 200 is confirmed, the data port transmits a stop pulse generated by the master device. In the I²C standard, that is a STOP condition generated by the master device 102. Accordingly, the one complete data transmission is done and thus next data transmission goes on.

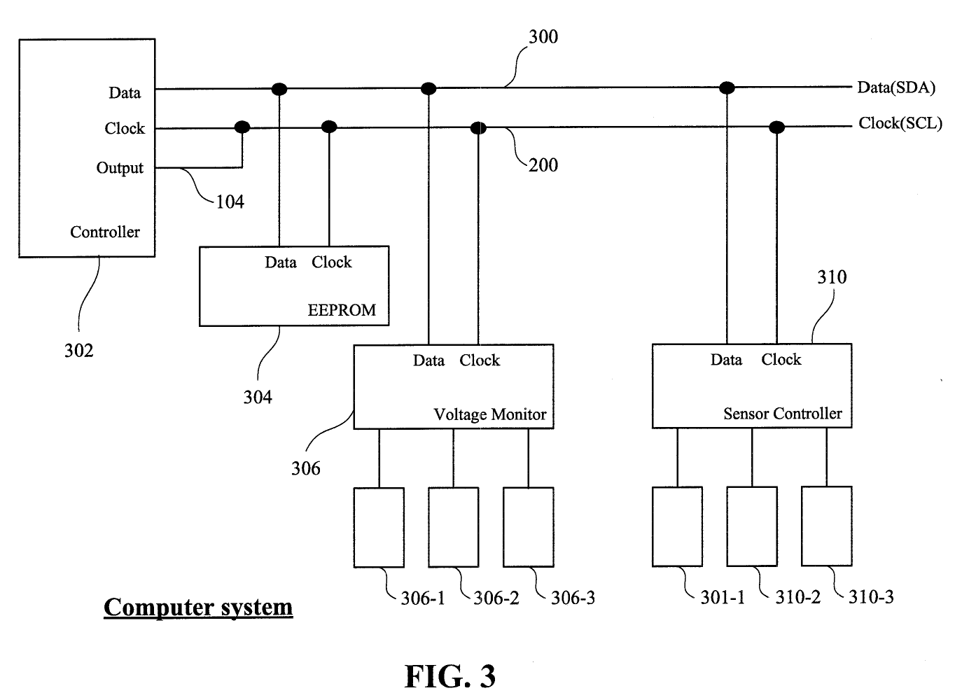

Please refer to FIG. 3, which illustrates a block diagram of a computer system capable of intercommunicating inside through a two-wire bus according to the present invention. The computer system, such as a IPMI server may mainly include a controller (such as a BMC) 302, an EEPROM 304, a voltage monitor 306, a master device 308 and a sensor controller 310. The voltage monitor 306 is employed to monitor voltages of the devices 306-1, 306-2 and 306-3, such as CPU voltage, UPS voltage, etc. The sensor controller 310 is employed to monitor the devices 306-1, 306-2 and 306-3, in such as FAN speed, CPU temp., HDD temp., etc. The controller 302 includes a data port, a clock port and a GPIO port. The data port transmits and receives data to/from one of the slave devices 304, 306, 310 through the data line 300. The clock port transmits a clock generated by the controller 302 to the slave devices 304, 306, 310 through the clock line 200 for providing the clock to the slave devices. The output port (such as a GPIO port) is also coupled to the clock line 200 by a wiring line 104 as shown in FIG. 3. Similarly as described in the first embodiment referring to FIG. 1, the controller 302 releases the clock held by any of the slave devices 304, 306, 310.

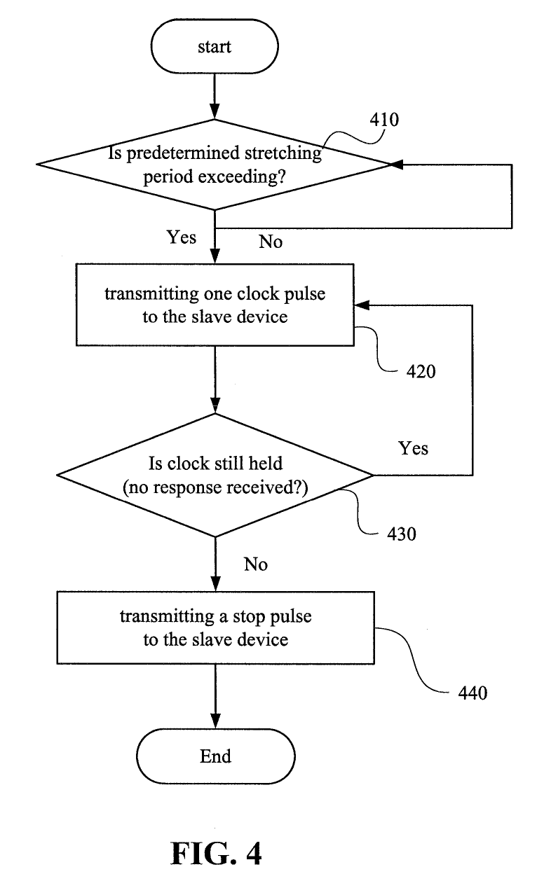

Please refer to FIG. 4, which depicts a flowchart of a method for releasing a clock line according to the first embodiment to accomplish the objective of the present invention. The method includes the following steps:

Step 410, confirming whether or not a clock is held by a slave device for exceeding a predetermined stretching period; if yes, proceeding to step 420; if no, remaining in step 410;

Step 420, transmitting one clock pulse to the slave device;

Step 430, checking if clock is still held (no response is received); if yes, returning to step 420; if no, proceeding to step 440; and

Step 440, transmitting a stop pulse to the slave device.

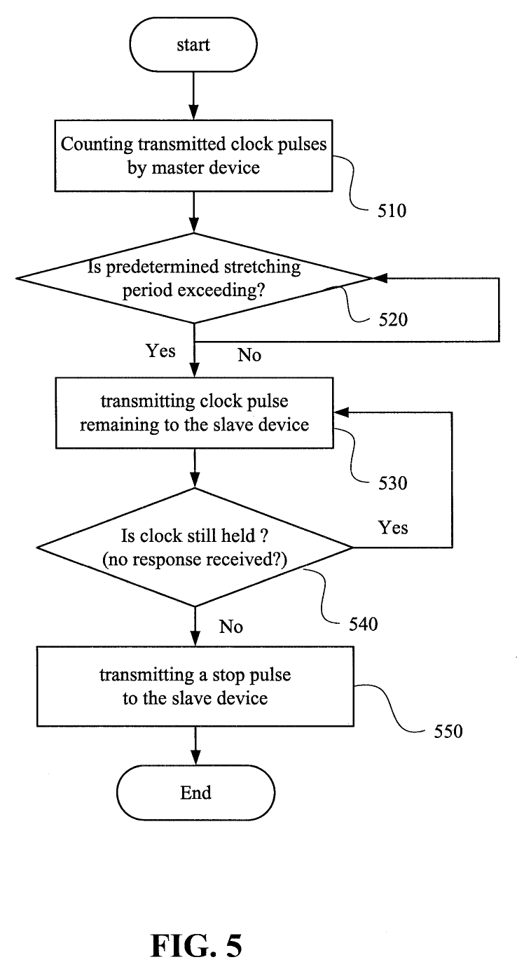

Please refer to FIG. 5, which depicts a flowchart of a method for releasing a clock line according to the second embodiment to accomplish the objective of the present invention. The method includes the following steps:

Step 510, counting transmitted clock pulses;

Step 520, confirming whether or not a clock is held by a slave device for exceeding a predetermined stretching period; if yes, proceeding to step 530; if no, remaining in step 520;

Step 530, transmitting the clock pulses remaining to the slave device;

Step 540, checking if clock is still held (no response is received); if yes, returning to step 530; if no, proceeding to step 550; and

Step 550, transmitting a stop pulse to the slave device.

Although the I²C standard is illustrated in the embodiments of the present invention, the I²C standard is not limited to the present invention. The present invention can also be applied to other two-wire buses, such as CAN-Bus, SMBus, etc. According to the present invention, a master device providing a release function which can release the clock line more efficiently and simpler, and the method thereof can be achieved and thus meets the easy, simple demand and spirit of two-wire bus standard.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A master device capable of communicating with a salve device via a two-wire bus having a clock line and a data line, the master device comprising:
a data port, transmitting and receiving data through the data line;
a clock port, transmitting a clock to the slave device through the clock line; and
an output port, coupled to the clock line, transmitting at least one clock pulse generated by the master device to the slave device so that the slave device releases the clock line.

2. The master device of claim 1, wherein the output port is a GPIO port.

3. The master device of claim 1, wherein the output port stops transmitting the clock pulse when the salve device receives a complete clock.

4. The master device of claim 1, wherein the output port stops transmitting the clock pulse when the salve device receives a 9-pulse clock.

5. The bus master device of claim 1, wherein the master device checks whether or not a response is received after the output port transmits the clock pulse each time.

6. The bus master device of claim 5, wherein releasing the clock line is confirmed by receiving the response via the data port.

7. The bus master device of claim 1, wherein the data port transmits a stop pulse generated by the master device after releasing the clock line is confirmed.

8. A master device capable of communicating with a salve device via a two-wire bus having a clock line and a data line, the master device comprising:
a first output port, transmitting and receiving data through the data line; and
a second output port, transmitting at least one clock pulse remaining to a slave device according to the two-wire bus standard when the clock is held by the slave device for exceeding a predetermined stretching period.

9. The master device of claim 8, wherein the first output port and the second output port are GPIO ports.

10. The master device of claim 8, wherein the second output port stops transmitting the clock pulse when the salve device receives a complete clock.

11. The master device of claim 8, wherein the second output port stops transmitting the clock pulse when the salve device receives a 9-pulse clock.

12. The master device of claim 8, wherein the master device checks whether or not a response is received after the second output port transmits the remaining clock pulses.

13. The master device of claim 12, wherein releasing the clock line is confirmed by receiving the response via the data port.

14. The master device of claim 8, wherein the first output port transmits a stop pulse generated by the master device after releasing the clock is confirmed.

15. A Computer system capable of intercommunicating inside via a two-wire bus having a clock line and a data line, the computer system comprising:
at least one slave device; coupled to the two-wire bus; and
a controller, coupled to the slave device via the two-wire bus, the controller comprising:
a data port, transmitting and receiving data through the data line;
a clock port, transmitting a clock to the slave device through the clock line; and
an output port, coupled to the clock line, transmitting at least one clock pulse generated by the controller to the slave device when the clock is held by the slave device for exceeding a predetermined stretching period.

16. The master device of claim 15, wherein the output port is a GPIO port.

17. The master device of claim 15, wherein the output port stops transmitting the clock pulse when the salve device receives a complete clock.

18. The master device of claim 15, wherein the output port stops transmitting the clock pulse when the salve device receives a 9-pulse clock.

19. The computer system of claim 15, wherein the controller checks whether or not a response is received after the output port transmits the clock pulse each time.

20. The computer system of claim 19, wherein releasing the clock line is confirmed by receiving the response via the data port.

21. The computer system of claim 15, wherein the data port transmits a stop pulse generated by the controller after releasing the clock line is confirmed.

22. A method for releasing a clock line of a two-wire bus, the method comprising steps of:
confirming whether or not a clock is held by a slave device; and
transmitting at least one clock pulse generated by a master device to the slave device when the clock is held for exceeding a predetermined stretching period.

23. The method of claim 22, further comprising a step of checking whether or not a response is received after the step of transmitting the clock pulse each time.

24. The method of claim 23, wherein releasing the clock line is confirmed by receiving the response.

25. The method of claim 23, further comprising a step of transmitting a stop pulse to the slave device after the step of checking whether or not a response is received.

26. The method of claim 22, further comprising a step of counting transmitted clock pulses before the confirming step.

27. The method of claim 26, wherein the step of transmitting at least one clock pulse is to transmit the clock pulses remaining according to the result of counting the transmitted clock pulses obeying the two-wire bus standard.

28. The method of claim 27, further comprising a step of checking whether or not a response is received after the step of transmitting the clock pulse remaining.

29. The method of claim 28, wherein releasing the clock line is confirmed by receiving the response.

30. The method of claim 26, further comprising a step of transmitting a stop pulse to the slave device after the step of transmitting the clock pulse.
